(19) United States
(12) Patent Application Publication
(10) Pub. No.: US 2021/0029217 A1
(43) Pub. Date: Jan. 28, 2021

(54) COMMUNICATION SUPPORT DEVICE, COMMUNICATION SUPPORT METHOD, AND PROGRAM

(71) Applicant: SONY CORPORATION, Tokyo (JP)

(72) Inventors: Kengo YOSHII, Tokyo (JP); Noriyuki SUZUKI, Chiba (JP); Hironari MIZUMURA, Tokyo (JP); Angie PARK, San Francisco, CA (US); Naoki OGISHITA, San Francisco, CA (US)

(73) Assignee: SONY CORPORATION, Tokyo (JP)

(21) Appl. No.: 16/521,097

(22) Filed: Jul. 24, 2019

(51) Int. Cl. H04L 29/08

(52) U.S. Cl. CPC H04L 67/32; H04L 67/141

(57) ABSTRACT

A communication support device includes: a compatibility determination unit configured to determine compatibility between a guest user who requests provision of a service and a host user who provides the service to the guest user; a communication unit configured to transmit a compatibility determination result to a terminal device of the guest user; and a connection processing unit configured to perform a connection process between the terminal device of the guest user and a terminal device of the host user.

### TECHNICAL FIELD

The present technology relates to a communication support device, a communication support method, and a program.

### BACKGROUND ART

In recent years, thanks to the spread and evolution of the Internet, communication support services have been proposed and used to collect information related to many people using the Internet, diagnose compatibility between people on the basis of the information, and introduce people with good compatibility.

As such a compatibility determination, for example, there has been proposed a method of collating a database for personality analysis to evaluate personal characteristics using input data such as the user's age, gender, blood type, and the like and measurement data by a sensor such as a heart rate, components of sweat, and the like, and determining compatibility on the basis of a matching rate of the personality characteristic data (PTL 1).

### CITATION LIST

### Patent Literature

### [PTL 1]

### JP 2016-126528A

### SUMMARY

### Technical Problem

However, the technology described in PTL 1 is to determine direct compatibility between a person and a person or whether or not their personalities match; however, a person-to-person relationship varies depending on what a person does with another person or what kind of compatibility are to be determined. For example, even if one person and another person are a compatible combination with age, blood type, hobbies, and the like, it does not mean that they are compatible in a relationship that the one person tell or teach things to the another person.

The present technology has been made in view of such a point, and it is desirable to provide a communication support device, a communication support method, and a program capable of determining compatibility between a user who provides a service and a user who receives the service to support their communication.

### Solution to Problem

In order to solve the problem described above, according to a first technology, there is a communication support device including a compatibility determination unit configured to determine compatibility between a guest user who requests provision of a service and a host user who provides the service to the guest user, a communication unit configured to transmit a compatibility determination result to a terminal device of the guest user, and a connection processing unit configured to perform a connection process between the terminal device of the guest user and a terminal device of the host user. Furthermore, according to a second technology, there is a communication support method including determining compatibility between a guest user who requests provision of a service and a host user who provides the service to the guest user, transmitting a compatibility determination result to a terminal device of the guest user, and performing a connection process between the terminal device of the guest user and a terminal device of the host user.

Furthermore, according to a third technology, there is a program that causes a computer to perform a communication support method and the method includes determining compatibility between a guest user who requests provision of a service and a host user who provides the service to the guest user, transmitting a compatibility determination result to a terminal device of the guest user, and performing a connection process between the terminal device of the guest user and a terminal device of the host user.

### BRIEF DESCRIPTION OF DRAWINGS

FIG. 1 is a block diagram illustrating a configuration of a remote communication system 10.

FIG. 2 is a block diagram illustrating a configuration of a host terminal device 100.

FIG. 3 is a block diagram illustrating a configuration of a guest terminal device 200.

FIG. 4 is a block diagram illustrating a configuration of a communication support device 300.

FIGS. 5A and 5B are diagrams illustrating a host user UI for initial setting.

FIGS. 6A and 6B are diagrams illustrating the host user UI for initial setting.

FIGS. 7A and 7B are diagrams illustrating the host user UI for initial setting.

FIG. 8 is a flowchart illustrating a process in the guest terminal device 200.

FIG. 9 is a diagram illustrating a UI for inputting a request.

FIGS. 10A and 10B are diagrams illustrating a UI for displaying host user information.

FIGS. 11A and 11B are diagrams illustrating a UI for displaying recommended host user information.

FIG. 12 is a flowchart illustrating a process in the host terminal device 100.

FIG. 13 is a diagram illustrating a UI of the host terminal device which displays a guest user who made a connection request.

FIG. 14 is a flowchart illustrating a process in the communication support device 300.

FIG. 15 is a diagram illustrating a UI of the host terminal device 100 during service provision.

FIG. 16 is a diagram illustrating a UI of the guest terminal device 200 during service provision.

FIGS. 17A and 17B are diagrams illustrating a UI in a case where a communication connection is kept connected.

FIGS. 18A and 18B are diagrams illustrating a UI for evaluation.

FIG. 19 is a diagram illustrating the UI for evaluation.

FIG. 20 is a block diagram illustrating a configuration of a compatibility determination unit 304.

FIG. 21 is an explanatory diagram of groups.

FIG. 22 is a flowchart of a compatibility determination process.

### DESCRIPTION OF EMBODIMENTS

Hereinafter, an embodiment of the present technology will be described with reference to the drawings. Note that the description will be given in the following order.

### <1. Embodiment>

[1-1. Configuration of remote communication system 10]
[1-2. Configuration of host terminal device 100 and guest terminal device 200]
[1-3. Configuration of communication support device 300]
[1-4. Outline of service provision]
[1-4-1. Initial setting]
[1-4-2. Process in guest terminal device 200]
[1-4-3. Processing in host terminal device 100]
[1-4-4. Processing in communication support device 300]
[1-4-5. Specific example of service provision]
[1-5. Configuration of compatibility determination unit 304]
[1-6. Compatibility determination process]
2. Modification examples

### 1. Embodiment

### [1-1. Configuration of Remote Communication System 10]

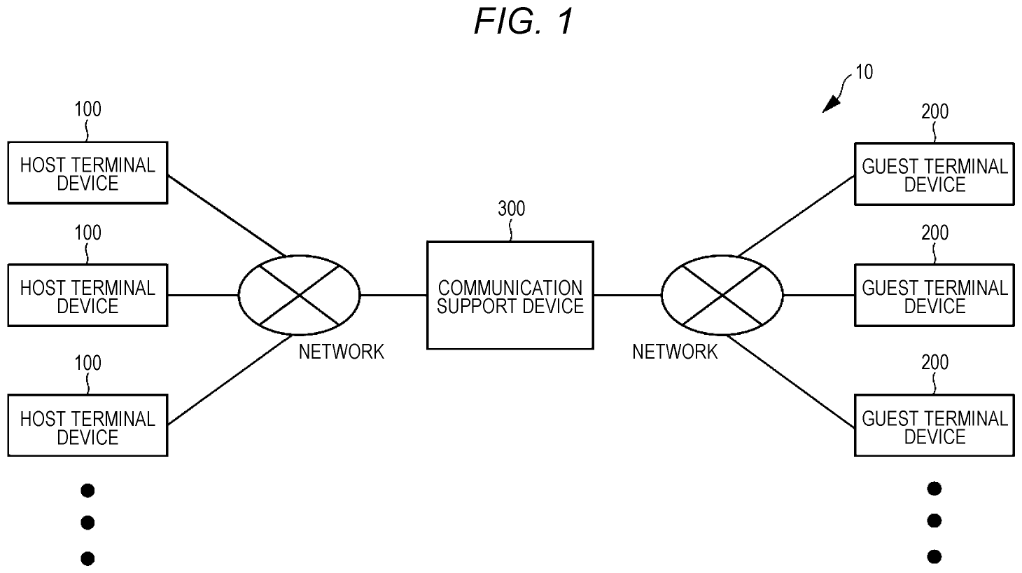

First, a configuration of a remote communication system 10 will be described with reference to FIG. 1. The remote communication system 10 includes a host terminal device 100 used by a person who provides a service (referred to as a host user), a guest terminal device 200 used by a person who sends a request for a service and receives a service provided from the host user (referred to as a guest user), and a communication support device 300 which performs compatibility determination and communication connection processing. In the present embodiment, a service represents that the host user provides information to the guest user upon request by transmitting video, image, voice, text data, or the like. The host terminal device 100 and the communication support device 300 are connected via a network, and the guest terminal device 200 and the communication support device 300 are also connected via the network. Note that FIG. 1 illustrates three host terminal devices 100 and three guest terminal devices 200; however, in actual, many host terminal devices 100 and guest terminal devices 200 are connected to the communication support device 300 via a network.

The host terminal device 100 is used by the host user to transmit a message or transmit a video to the guest terminal device 200 for service provision.

The guest terminal device 200 is used by a guest user to transmit a request to the communication support device 300, transmit a message to the host terminal device 100, or receive and displays a video transmitted from the host terminal device 100.

The communication support device 300 performs processing such as determining compatibility between a guest user and a large number of host users in service provision, transmitting information regarding a host user with good compatibility (referred to as a recommended host user) to the guest terminal device 200 to presents the information to the guest user, establishing a communication connection between the host terminal device 100 and the guest terminal device 200, transmitting a video or the like from the host terminal device 100 to the guest terminal device 200, and the like.

### [1-2. Configuration of Host Terminal Device 100 and Guest Terminal Device 200]

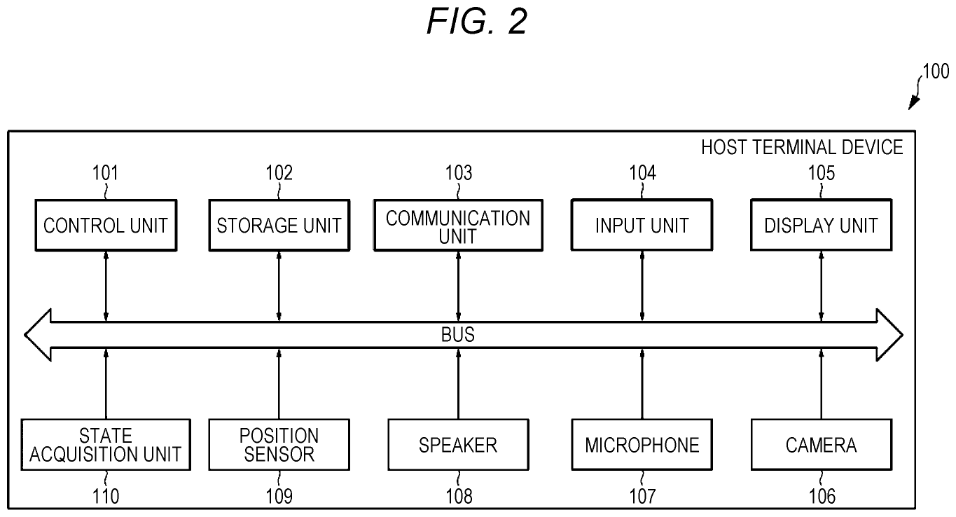

Next, a configuration of the host terminal device 100 will be described with reference to FIG. 2. The host terminal device 100 includes at least a control unit 101, a storage unit 102, a communication unit 103, an input unit 104, a display unit 105, a camera 106, a microphone 107, a speaker 108, a position sensor 109, and a state acquisition unit 110.

The control unit 101 includes a central processing unit (CPU), a random access memory (RAM), a read only memory (ROM), and the like. The CPU executes various processes in accordance with a program stored in the ROM and issues commands to control the entire device and each part of the host terminal device 100.

The storage unit 102 is, for example, a mass storage medium such as a hard disk or a flash memory. The storage unit 102 stores various applications and data used in the host terminal device 100.

The communication unit 103 is a communication module for transmitting and receiving data and various information to and from the communication support device 300. The communication may be performed with any method as long as it is connected to the Internet or another device, such as a wireless local area network (LAN), a wide area network (WAN), wireless fidelity (WiFi), a fourth generation mobile communication system (4G), a fifth generation mobile communication system (5G), broadband, and the like.

The input unit 104 is used by the host user to input information and messages to the host terminal device 100 and to give various instructions. In a case where an input is made to the input unit 104 by the user, a control signal corresponding to the input is generated and supplied to the control unit 101. Then, the control unit 101 performs various processes corresponding to the control signal. The input unit 104 includes a touch panel, a touch screen integrally formed with a monitor, and the like, in addition to physical buttons.

The display unit 105 is a display device such as a display that displays an image/video, a graphical user interface (GUI), and the like.

The camera 106 includes a lens, an imaging element, a video signal processing circuit, and the like, and is for capturing a live image or an image transmitted from the host terminal device 100 to the guest terminal device 200. The microphone 107 is used by the host user to input sound to the host terminal device 100. The host user operates the host terminal device 100, inputs a message to be transmitted to the guest terminal device 200, and the like by sound input and sound recognition technology. Furthermore, the microphone 107 is also used as a sound input device in voice communication or video communication with the guest terminal device 200.

The speaker 108 is a sound output device that outputs a voice message, video sound, and the like.

The position sensor 109 is a sensor such as global positioning system (GPS) that can detect the current position of the host terminal device 100.

The state acquisition unit 110 detects and acquires a current status of the host terminal device 100 such as a login status and a connection status of the host terminal device 100 to the remote communication system 10. The status information of the host terminal device 100 is transmitted to the communication support device 300 by the communication unit 103.

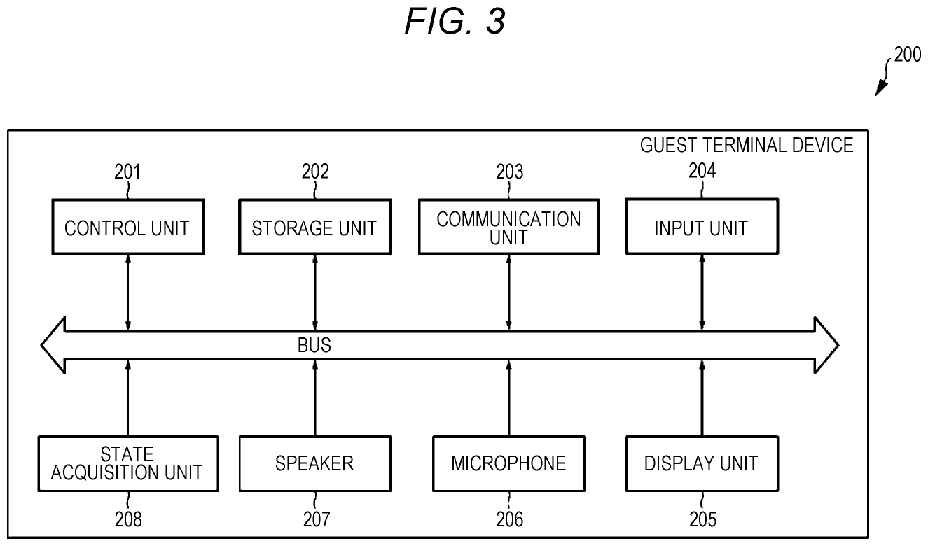

The host terminal device 100 is configured as described above. Specific examples of the host terminal device 100 include, for example, a smartphone, a tablet terminal, a personal computer, a wearable device, and a portable game machine. The control program for performing the process according to the embodiment of the present technology in the host terminal device 100 may be installed in advance in the host terminal device 100, or may be distributed as a program to be downloaded, stored in a storage medium, or the like and manually installed by the host user. Next, a configuration of the guest terminal device 200 will be described with reference to FIG. 3. The guest terminal device 200 includes at least a control unit 201, a storage unit 202, a communication unit 203, an input unit 204, a display unit 205, a microphone 206, a speaker 207, and a state acquisition unit 208. The components other than the state acquisition unit 208 are similar to those in the host terminal device 100, and thus the description thereof is omitted.

The state acquisition unit 208 detects and acquires a current status of the guest terminal device 200 such as a login status and a connection status of the guest terminal device 200 to the remote communication system 10. The status information of the guest terminal device 200 is transmitted to the communication support device 300 by the communication unit 203.

Specific examples of the guest terminal device 200 include, for example, a smartphone, a tablet terminal, a personal computer, a wearable device, a portable game machine, and the like. The control program for performing the process according to the embodiment of the present technology in the guest terminal device 200 may be installed in advance in the host terminal device 100 or may be distributed as a program to be downloaded, stored in a storage medium, or the like and manually installed by the guest user.

### [1-3. Configuration of Communication Support Device 300]

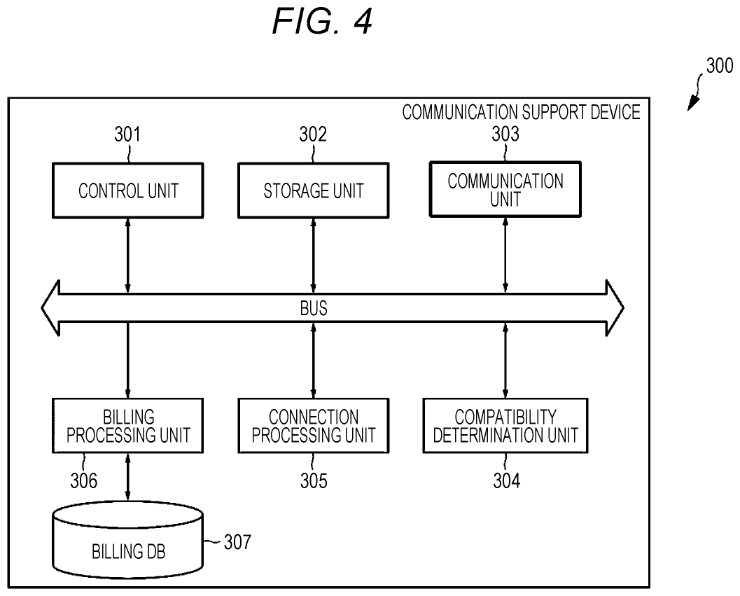

Next, a configuration of the communication support device 300 will be described with reference to FIG. 4. The communication support device 300 includes a control unit 301, a storage unit 302, a communication unit 303, a compatibility determination unit 304, a connection processing unit 305, a billing processing unit 306, and a billing database 307. Note that the control unit 301 and the storage unit 302 are similar to those in the host terminal device 100, and thus the description thereof is omitted.

The communication unit 303 is a communication module for transmitting and receiving data and various information to and from the host terminal device 100 and the guest terminal device 200. More specifically, the communication unit 303 transmits the compatibility determination result to the guest terminal device 200, receives a connection request from the guest terminal device 200, and transmits and receives video data, sound data, and text data used in service provided from the host terminal device 100 to the guest terminal device 200. Any communication method such as a wireless LAN, WAN, WiFi, 4G, 5G, broadband, or the like may be used as long as a connected to a network is available.

The compatibility determination unit 304 determines the compatibility between the guest user who receives the service and the host user who provides the service. The result of the compatibility determination is transmitted by the communication unit 303 to the guest terminal device 200 as “recommended host user information”. Details of the compatibility determination unit 304 will be described later.

The connection processing unit 305 performs a process for connecting the guest terminal device 200 and the host terminal device 100 of the specific host user in a case where the guest user gives an instruction for communication connection with the specific host user on the basis of the result of the compatibility determination. Here, the connection means transfer of data necessary for providing the service, such as video data, sound data, image data, text chat data, or the like transmitted from the host terminal device 100 to the guest terminal device 200 and also establish a direct communication connection between the terminal device 100 and the guest terminal device 200. Note that, in a case where the host terminal device 100 and the guest terminal device 200 directly communicate, the communication content needs to also be transmitted to be the communication support device 300 to acquire history data of the service content or the like. The connection processing unit 305 establishes the connection between the guest terminal device 200 and the host terminal device 100 so that a service can be provided.

The billing processing unit 306 processes bill payment from the guest user to the host user performed during the service provision by the host user or after the service is ended, and updates billing data in the billing database 307.

The billing database 307 stores and manages data indicating amounts that all the host users obtained through service provision and amounts paid by the guest users. In a case where the user receives a bill payment as a host user or makes a payment as a guest user, the billing processing unit 306 updates the billing database 307. Note that, as the billing, there are a bill payment based on a length of connection time to be paid after the service is terminated, a tip to be paid during the service and/or after the service is terminated, and the like.

The communication support device 300 is configured as described above. The communication support device 300 is configured on, for example, a server or a cloud. A control program that performs processing according to the embodiment of the present technology in the communication support device 300 may be installed to a server or a processing unit of a cloud in advance, or may be distributed as a program to be downloaded or stored in a storage medium, or the like and manually installed by the user of the communication support device 300.

### [1-4. Outline of Service Provision]

### [1-4-1. Initial Setting]

Next, an outline of service provision in the remote communication system 10 will be described. The host user and the guest user use the remote communication system 10 in the form of using an application operating on each terminal device. Note that, in the following description, “input” may be performed by any input method such as an input using a hardware button, an input using a software keyboard, a voice input, and the like.

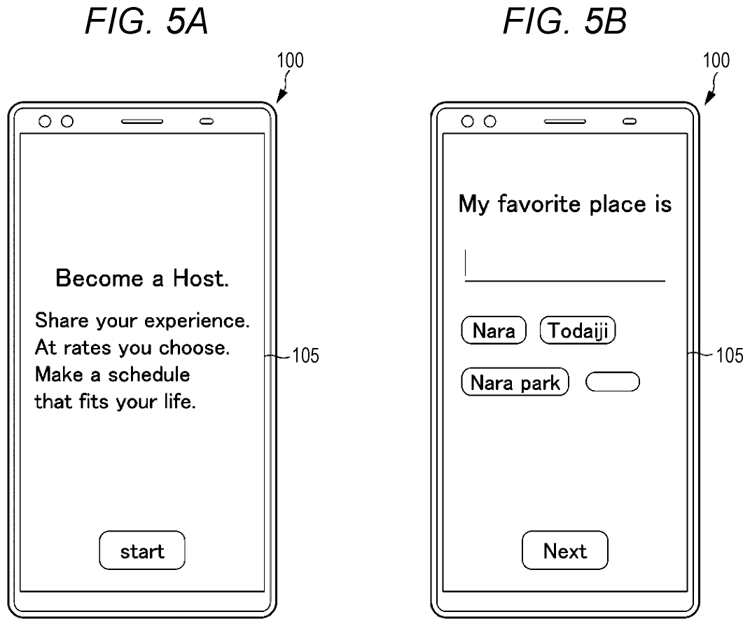

First, initial setting to use the remote communication system 10 will be described. As illustrated in FIG. 5A, a guide display of the remote communication system 10 is displayed on the display unit 105 of the host terminal device 100, and the user who is trying to be a host user performs an input on the Start button.

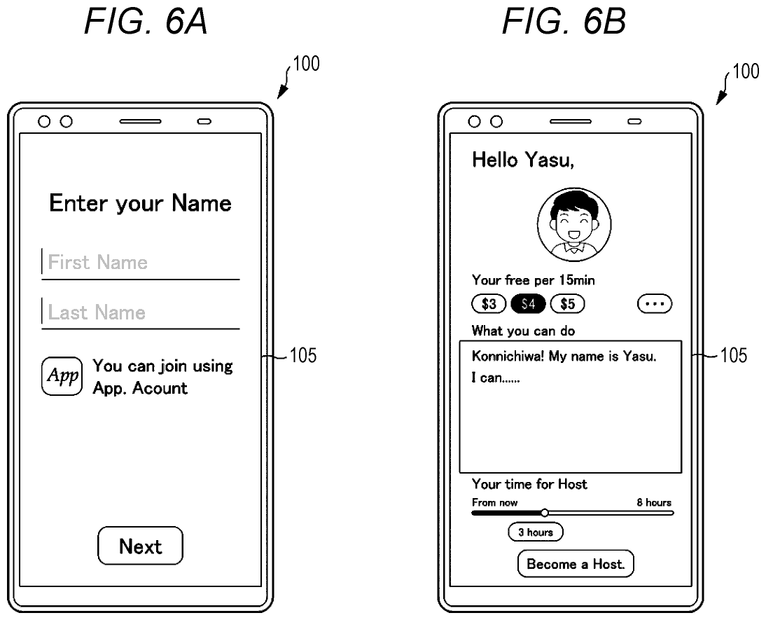

In a case where an input is made to the Start button, the display changes and, on a UI displayed on the display unit 105 as illustrated in FIG. 5B, the user trying to be a host user inputs his/her interests, concerns, hobbies, knowledge, specialties, and the like by inputting specific information such as his/her favorite places, favorite events, favorite brand, favorite books, favorite websites, or the like. Furthermore, as illustrated in FIG. 6A, the user inputs personal information such as a name, a postal address, date of birth, bank account, and the like. The input content is transmitted to the communication support device 300 by the communication unit 103, and the host user is integrally managed in the communication support device 300 on the basis of the information. Furthermore, these pieces of information are also used in compatibility determination by the communication support device 300 as information indicating an attribute of the host user. Note that the above-described input content is merely an example, and the more the input content, the more the attribute information used for the compatibility determination, and the accuracy of the compatibility determination can be enhanced.

Also, as illustrated in FIG. 6B, the user trying to be the host user inputs his/her service provision rate settings. Since service provision is performed by transmission of real-time video, audio, and text chat, a fee is set for a unit time (15 minutes, for example) while the communication connection is established and the service provision is available. Furthermore, as illustrated in FIG. 6B, the host user inputs the contents of the service that he/she can provide. These input contents are transmitted to the communication support device 300 by the communication unit 103.

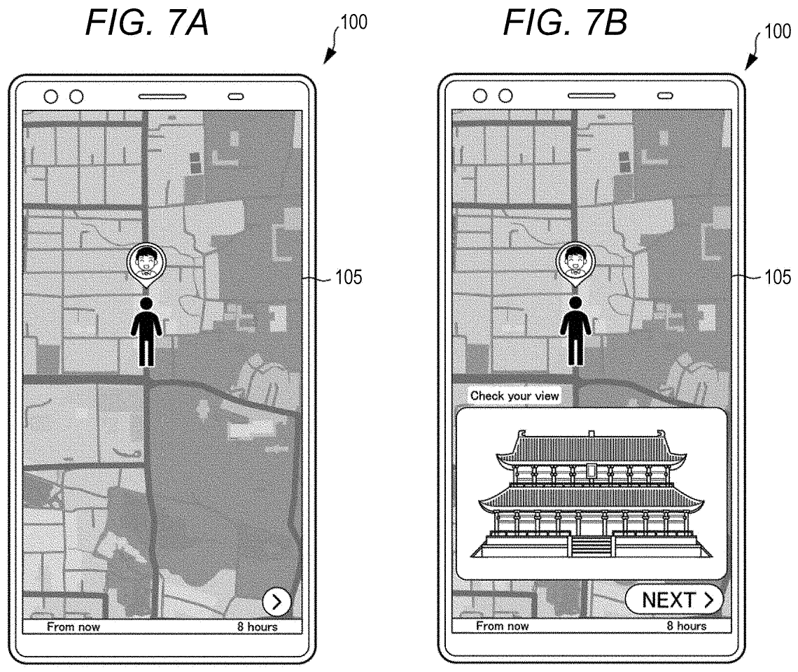

After completing the input of the above contents, the user trying to be a host user performs input on an application button (the Become a Host button in FIG. 6B) for applying the registration application to the communication support device 300. In a case where an input is made to the application button, the application is transmitted to the communication support device 300, and when approval is received from the communication support device 300, the user can become a host user. Next, as illustrated in FIG. 7A, the current position of the host user is displayed on a map on the display unit 105 of the host terminal device 100. The current position of the host user is acquired by the position sensor 109. Next, as illustrated in FIG. 7B, a through image showing an image captured by the camera 106 is displayed on the display unit 105. The host user can adjust the angle of view and the like by looking at the display.

Then, in a case where a button (the NEXT button in FIG. 7B) giving an instruction for setting completion displayed on the display unit 105 of the host terminal device 100 is pressed, the current position information of the host user and the image taken by the camera 106 are transmitted to the communication support device 300, and displayed on a large number of guest terminal devices 200 via the communication support device 300.

In a similar manner, the user who desires to be a guest user also inputs his/her personal information, interest and the like to the guest terminal device 200. The input content is transmitted to the communication support device 300 by the communication unit 203. However, since the guest user is a party who receives the provision of information from the host user and pays a fee, a billing setting or something that the user can provide is not necessary to input. There is also no need to adjust the angle of view of the camera.

### [1-4-2. Process in Guest Terminal Device 200]

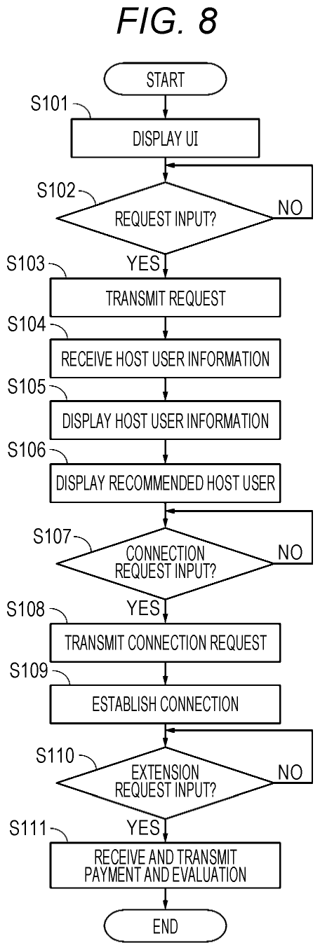

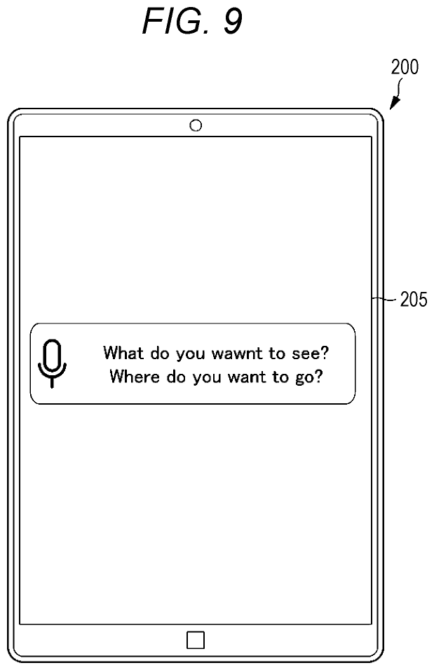

Next, a process in the guest terminal device 200 for using the remote communication system 10 will be described with reference to the flowchart of FIG. 8. First, in step S101, as illustrated in FIG. 9, a UI for using the remote communication system 10 is displayed on the display unit 205. In this UI, the guest user inputs a request for a desirable service to receive from the host user. For example, in a case where a remote travel experience of a specific sightseeing spot is desired, the user can input “I want to go to Nara” or “I want to see a temple in Nara”. This input may be in another expression such as “Go to Nara” or “Nara”.

In a case where there is a request input, the process proceeds from step S102 to step S103 (Yes in step S102), and the guest terminal device 200 transmits the request to the communication support device 300. Next, in step S104, the guest terminal device 200 receives host user information from the communication support device 300. The host user information is location information, detailed information, and the like of the host user who can provide the service for the request.

For example, in a case where the guest user's request is a travel simulation experience of a predetermined place such as “I want to go to Nara”, position information, detailed information, and the like of all host users currently existing near the predetermined place and recommended host users determined by the communication support devices 300 to be compatible are considered as host user information.

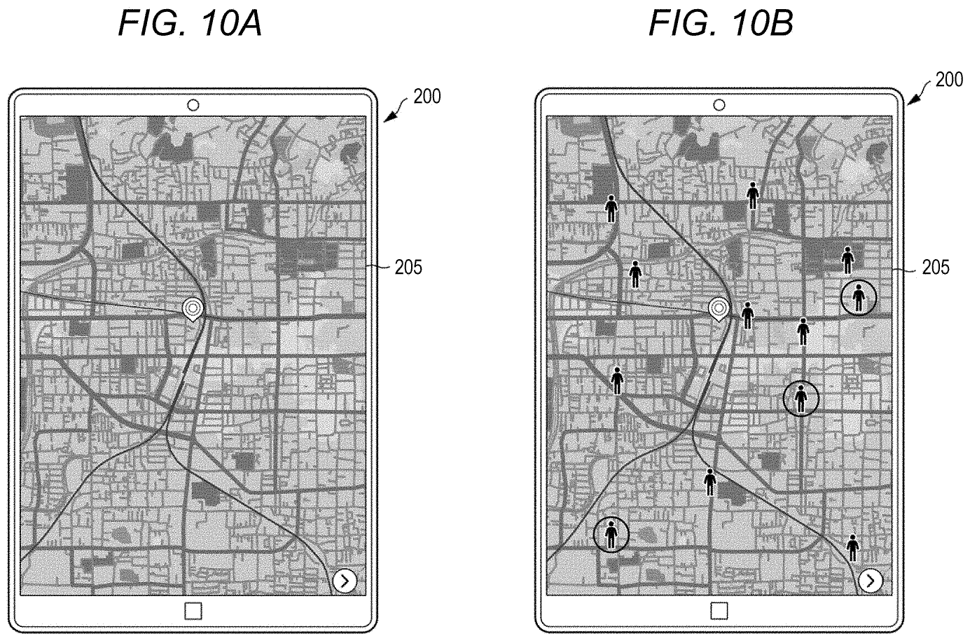

Next, in step S105, the host user information is displayed on the display unit 205 of the guest terminal device 200. For example, in a case where the guest user's request is a travel simulation experience of a specific place such as “I want to go to Nara”, a map including the specific place is displayed on the display unit 205 as illustrated in FIG. 10A and also the all host users in a predetermined range around the specific place are displayed as icons on the map as illustrated in FIG. 10B.

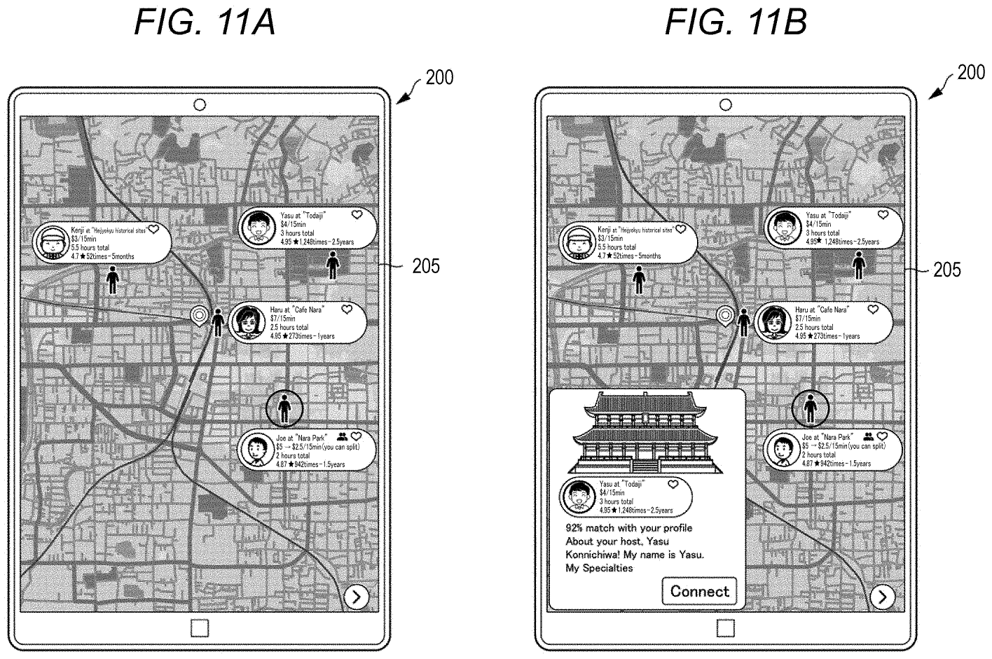

In the display of FIG. 10B, the host users are displayed as human-shaped icons, and the icons which are not circled represent host users who is not currently connected to another guest user, and the icon which are circled represent host users who is currently connected with another guest user (but available for a connect with other guest users). Here, some icons are distinguished by being circled for convenience of the description of the drawings; however, in an actual display, the icons are preferably distinguished by colors for easier visual recognition. For example, an icon representing a host user who is not currently connected to another guest user is displayed in green, a host user currently connected to another guest user is displayed in red, and the like. Next, in step S106, as illustrated in FIG. 11A, information regarding a recommended host user compatible with the guest user in service provision is displayed on the display unit 205. In this display, the distinction between a host user who is not currently connected to another guest user and a host user who is currently connected to another guest user is similar to the case illustrated in FIG. 10B. Note that only the display of the recommended host user in step S106 may be performed without performing step S105.

In a case where a predetermined selection input such as a tap operation is performed on the icon representing the host user in the display state of FIG. 11A, detailed information of the host user is displayed as illustrated in FIG. 11B. Here, the guest user can confirm what kind of person the host user is, his/her service provision experience, the fee, and the like. Note that the display of the detailed information may be a superimposed display as illustrated in FIG. 11B or may be displayed by changing the entire display.

Then, in a case where the host user from whom the provision of the service is received is determined, the guest user performs an input on the connection request button (“Connect” button in FIG. 11B). In a case where there is a connection request from the guest user, the process proceeds from step S107 to step S108 (Yes in step S107).

Next, in step S108, the guest terminal device 200 transmits the connection request to the communication support device 300. This connection request is transmitted from the communication support device 300 to the host terminal device 100 and, in a case where the connection is approved in the host terminal device 100, the connection between the guest terminal device 200 and the host terminal device 100 is established as indicated in step S109. Note that the connection is established by the connection processing unit 305 of the communication support device 300.

While the guest terminal device 200 and the host terminal device 100 are connected, a service is provided from the host user to the guest user.

As described above, since the remote communication system 10 according to the present embodiment is a service in predetermined time units, the connection is terminated in a case where there is no input giving an instruction for a connection extension from the guest user as indicated in step S109.

Then, in step S111, the guest terminal device 200 receives an input of a bill payment and evaluation from the guest user to the host user, and transmits the payment and evaluation to the communication support device 300. The process in the guest terminal device 200 ends here.

### [1-4-3. Processing in Host Terminal Device 100]

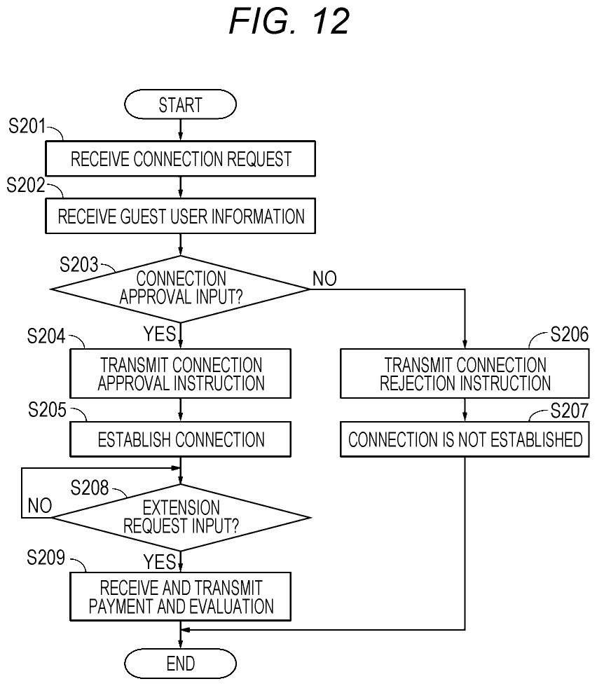

Next, a process in the host terminal device 100 for using the remote communication system 10 will be described with reference to the flowchart of FIG. 12.

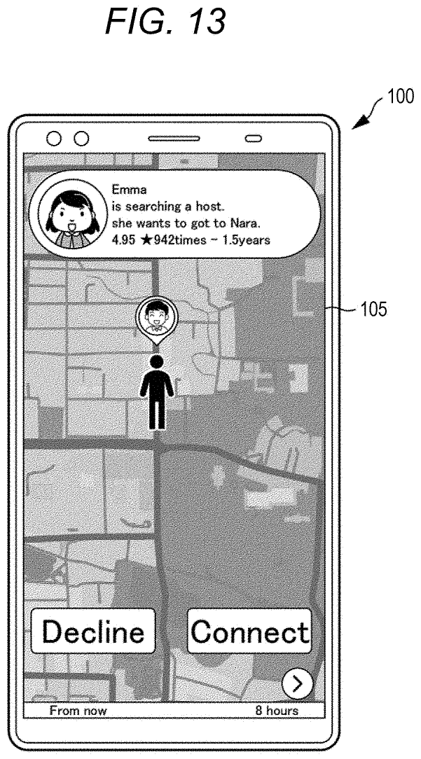

First, in step S201, the host terminal device 100 receives a connection request from the guest terminal device 200 via the communication support device 300. Next, in step S202, information regarding the guest user who has transmitted the connection request is received from the communication support device 300. Here, as illustrated in FIG. 13, the host terminal device 100 displays information regarding the guest user who has sent the connection request on the display unit 105 to allow to confirm what kind of person the guest user requesting the connection is.

Next, in a case where there is an input for approving the connection from the host user, the process proceeds from step S203 to step S204 (Yes in step S203), and transmits a connection approving instruction to the communication support device 300.

Then, in step S205, the connection between the guest terminal device 200 and the host terminal device 100 is established. Note that the connection is established by the connection processing unit 305 of the communication support device 300.

On the other hand, in a case where there is an input not approving the connection from the host user, the process proceeds to step S206 (No in step S203), and a connection rejection instruction is transmitted to the communication support device 300. Then, in step S207, the connection between the guest terminal device 200 and the host terminal device 100 is not established, and the process ends. Note that in a case where the guest user does not input connection approval or connection rejection within a predetermined period of time after receiving the connection request, a connection rejection instruction may be transmitted to the communication support device 300. Alternatively, the instruction may be transmitted to the communication support device 300 only in a case where the connection is approved, and the guest terminal device 200 may transmit nothing to the communication support device 300 in a case where the connection is refused.

While the guest terminal device 200 and the host terminal device 100 are connected, a service is provided from the host user to the guest user.

As described above, since the remote communication system 10 provides a service of a predetermined time unit, the connection is terminated in a case where the guest user does not request a connection extension as indicated in step S208.

Then, in step S209, the host terminal device 100 receives an input of a bill payment and evaluation from the guest user to the host user, and transmits the payment and evaluation to the communication support device 300. The processing in the host terminal device 100 is completed here.

### [1-4-4. Processing in Communication Support Device 300]

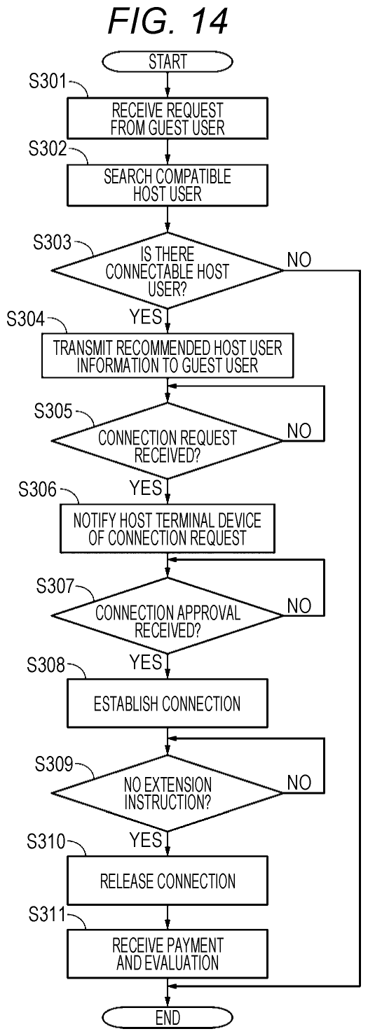

Next, a process in the communication support device 300 will be described with reference to the flowchart in FIG. 14. First, in step S301, the communication support device 300 receives a request input by a guest user from the guest terminal device 200. Next, in step S302, in the communication support device 300, a compatible host user in the service provision requested by the guest user is searched in a compatibility determination process. Then, in a case where there is a compatible and connectable host user, the process proceeds from step S303 to step S304 (Yes in step S303). On the other hand, in a case where there is no connectable host user, the process ends (No in step S303).

Next, in step S304, the communication support device 300 transmits, to the guest terminal device 200, recommended host user information and information regarding the recommended host user (information informing what kind person the host user is, including age, gender, hobby, and the like).

Next, in a case where the communication support device 300 receives a connection request from the guest terminal device 200, the process proceeds from step S305 to step S306 (Yes in step S305), and notifies the host terminal device 100 of the connection request.

Then, in a case where the connection approval is received from the host terminal device 100, the process proceeds from step S307 to step S308 (Yes in step S307), and the connection processing unit 305 establishes a connection between the guest terminal device 200 and the host terminal device 100. While the host terminal device 100 and the guest terminal device 200 are connected, a service is provided from the host user to the guest user. Next, as indicated in step S309, in a case where there is no instruction for connection extension from the guest terminal device 200, the connection processing unit 305 releases the connection between the host terminal device 100 and the guest terminal device 200 as indicated in step S310 and terminates the connection state. Then, in step S311, a payment and evaluation are received from the host terminal device 100 and the guest terminal device 200 and the process ends. Note that, in a case where an instruction for connection extension is received from the guest terminal device 200, the connection processing unit 305 is only required to maintain the connection state without performing an extra process.

### [1-4-5. Specific Example of Service Provision]

Next, a specific example of the service provided by the host user to the guest user will be described. Here, as described above, the guest user requests as “I want to go to Nara”, and the host user provides the guest user with a remote travel experience as a service through video, audio, text chat, and the like.

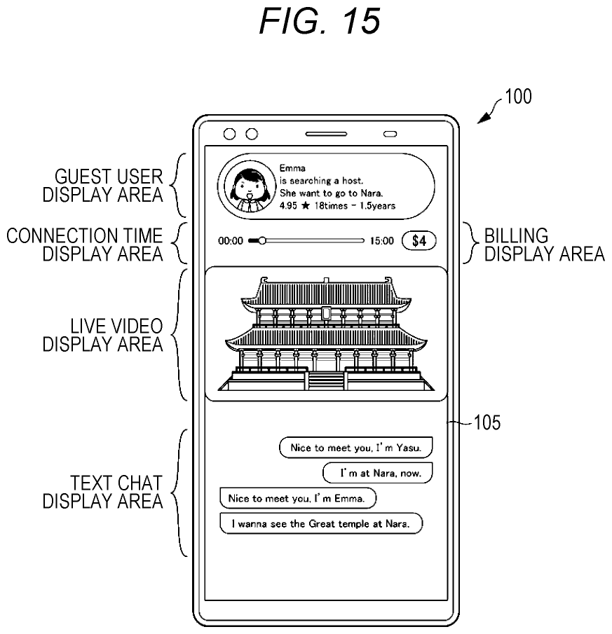

FIG. 15 illustrates a UI displayed on the display unit 105 of the host terminal device 100 in a case where the host terminal device 100 and the guest terminal device 200 are connected.

The host user UI includes a guest user display area, a connection time display area, a billing display area, a live video display area, and a text chat display area. In the guest user display area, information regarding the guest user such as a name of the currently connected guest user, an outline of a request, evaluation average, a usage period of the remote communication system 10, and the like is displayed.

In the connection time display area, a bar indicating elapsed of time from the start of connection and a numerical value representing the time are displayed. For example, in a case where the bill payment of the remote communication system 10 is in units of 15 minutes, a right end of the bar is configured to indicate an end of a unit of 15 minutes. This allows the host user to easily recognize the elapsed time from the start of connection.

The billing display area indicates a total amount of bill payment received from the guest user during connection. The live video display area displays real-time live video, which is being captured by the camera 106 of the host terminal device 100 and transmitted to the guest terminal device 200 via the communication support device 300. Since this video display may be displayed as a through image, the host user can change or adjust an angle of view or an object to be captured by looking at the live video display area. Note that a still image may be displayed in the live video display area.

In a case where a smartphone or a tablet terminal has an in-camera (camera on the display side) and an out-camera (camera on the opposite side of the display), the video taken by the out-camera is displayed on the live video display area to provide the guest user a video close to the host user's view.

The text chat display area is for displaying a history and an input field of text chat performed between the host terminal device 100 and the guest terminal device 200.

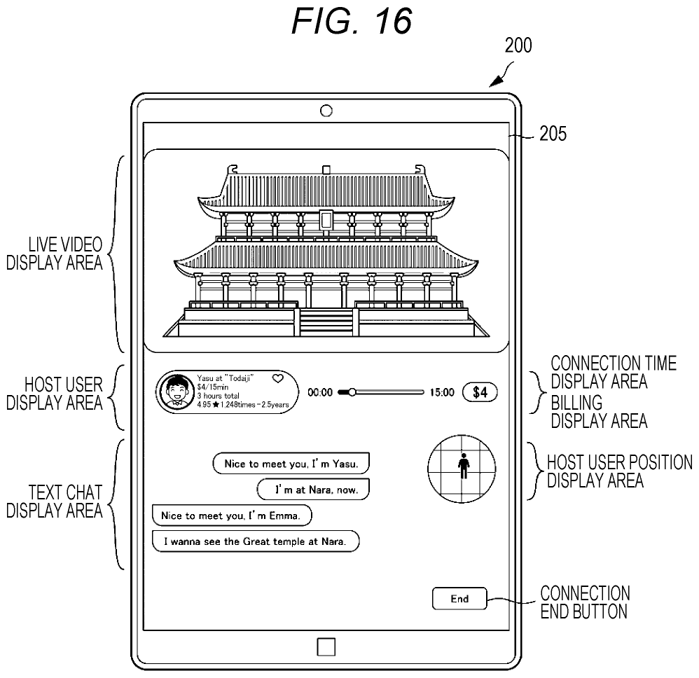

FIG. 16 illustrates a UI displayed on the display unit 205 of the guest terminal device 200 while the host terminal device 100 and the guest terminal device 200 are connected.

The guest user UI includes a host user display area, a connection time display area, a charge input area, a live video display area, a text chat display area, a host user position display area, and a connection end button.

The host user display area displays information regarding the host user such as a name of the host user currently connected, evaluation average, a usage period of the remote communication system 10, and the like.

The connection time display area and the text chat display area are similar to those in the host user UI. The live video display area is for displaying a video captured by the host terminal device 100 in real time. By looking at this, the guest user can confirm the state of the place where the host user is at present, the scenery, the information that the host user desires to convey to the guest user, and the like. Note that a still image captured by the host terminal device 100 may be displayed in the live video display area.

The host user position display area indicates the current position of the host user by superimposing an icon indicating the position of the host user on the map. The position information of the host user is acquired by the position sensor 109 of the host terminal device 100, and the position information is transmitted to the guest terminal device 200 via the communication support device 300 in real time.

The connection end button (the End button in FIG. 16) is used in a case where the guest user ends the connection with the host user.

Note that, while this UI is being displayed, it is assumed that the voice communication function is turned on in both the host terminal device 100 and the guest terminal device 200 so that a call can be made. However, in a case where one or both of the host user and the guest user are in a place where calls may not be made, the call function may be turned off and text chat may be conducted.

In a case where the host terminal device 100 and the guest terminal device 200 are connected, the host user UI is displayed on the host terminal device 100, and the guest user UI is displayed on the guest terminal device 200 so that the host user can provide the remote communication system 10 to the guest user.

For example, in a case where the guest user desires to know the state of a specific sightseeing spot (for example, a temple) in “Nara”, the host user is notified of a request “I want to see the inside of the temple”. The host user who heard the request may move to the temple to capture an appearance of the temple with the camera 106 showing the appearance with a video, or enters in the temple to capture a condition inside the temple with the camera 106 showing the condition with a video. Furthermore, the host user can also convey information about the temple to the guest user through conversation or text chat using a voice call function while moving or c capturing an image with the camera 106.

Then, in a case where the unit time (for example, 15 minutes) of bill payment approaches, the host terminal device 100 and the guest terminal device 200 are notified that the unit time for bill payment will soon be over with a sound and/or a display on the UI.

In a case where the connection is terminated and the remote communication system 10 is ended, the guest user performs an input on the connection end button. In a case where the connection is continued to keep receiving the service, the guest user may ignore the notification and may not input in the connection end button.

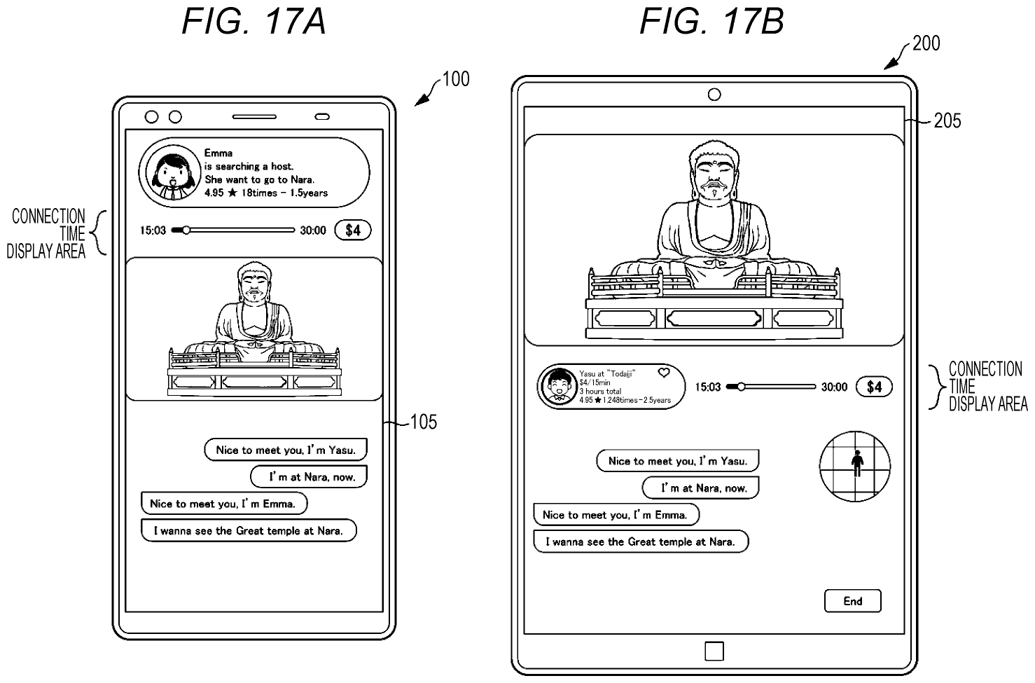

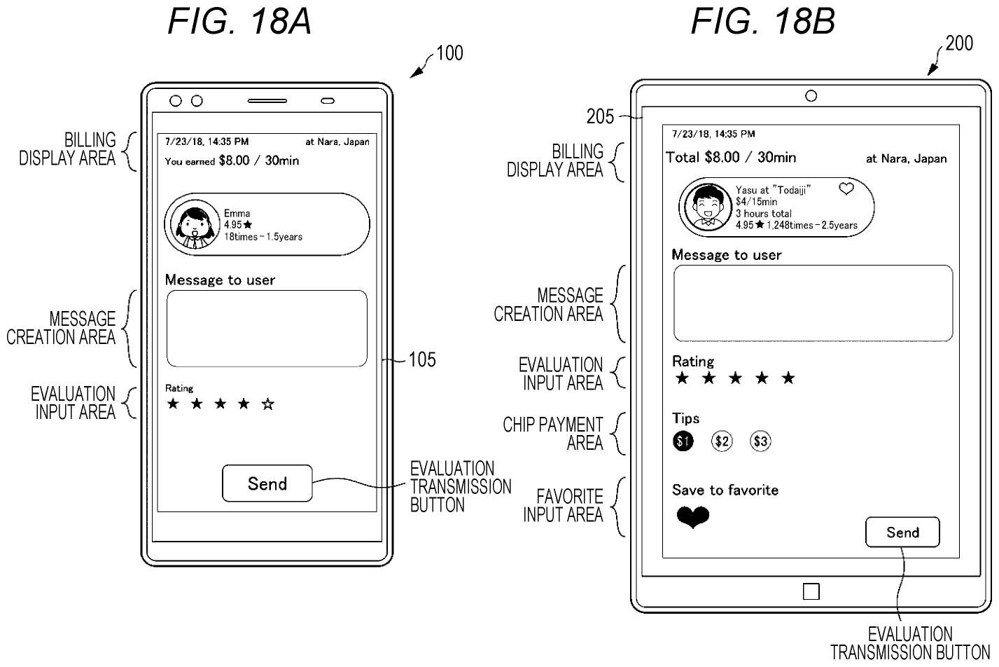

In a case where the communication connection is continued, the display of the connection time display area is updated in the host user UI as illustrated in FIG. 17A as well as in the guest user UI as illustrated in FIG. 17B. In a case where the guest user inputs the connection end button (End button) illustrated in FIG. 16, the connection between the host terminal device 100 and the guest terminal device 200 is disconnected, and the service provision is terminated. Then, as illustrated in FIG. 18A, the display on the display unit 105 of the host terminal device 100 changes to an evaluation UI for evaluating the guest user. This evaluation UI includes a billing display area indicating the amount of money obtained by this service provision, a message creation area for creating a message to the guest user, an evaluation input area (for example, five-grade evaluation), and an evaluation transmission button (Send button).

Furthermore, as illustrated in FIG. 18B, the display on the display unit 205 of the guest terminal device 200 changes to an evaluation UI for evaluating the host user. This evaluation UI includes a billing display area indicating an amount of money paid in the current remote communication system 10, a message creation area for creating a message to the host user, a host user evaluation area (for example, five-grade evaluation), a chip payment area, a favorite input area, and an evaluation transmission button (Send button).

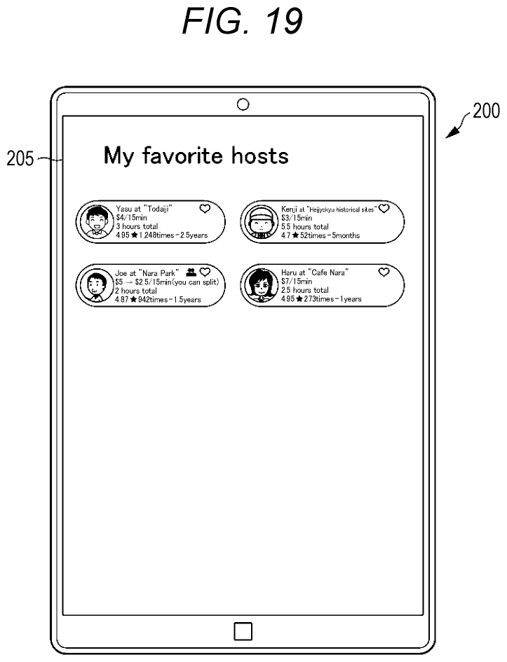

By inputting on the favorite input button, as illustrated in FIG. 19, the host user can be added to his/her favorite list, and searching for and connecting to the host user through the remote communication system 10 becomes easier thereafter. The favorite information of the guest user is transmitted to the communication support device 300 and is managed as a database in the communication support device 300 for each guest user. Note that the above described remote travel experience is an example of a service that can be realized by the remote communication system 10, and the service is not limited to the example. The remote communication system 10 is capable of providing a guest user decision support by the host user.

The host user may be able to select whether or not to connect to more than one guest user at the same time. Note that, in a case where the host user is set to connect to more than one guest user at the same time, multiple guest users receive the same service at the same time, so the billing payment to the host user may be divided or distributed by multiple guest users.

### [1-5. Configuration of Compatibility Determination Unit 304]

Next, the compatibility determination process performed in the compatibility determination unit 304 of the communication support device 300 will be described.

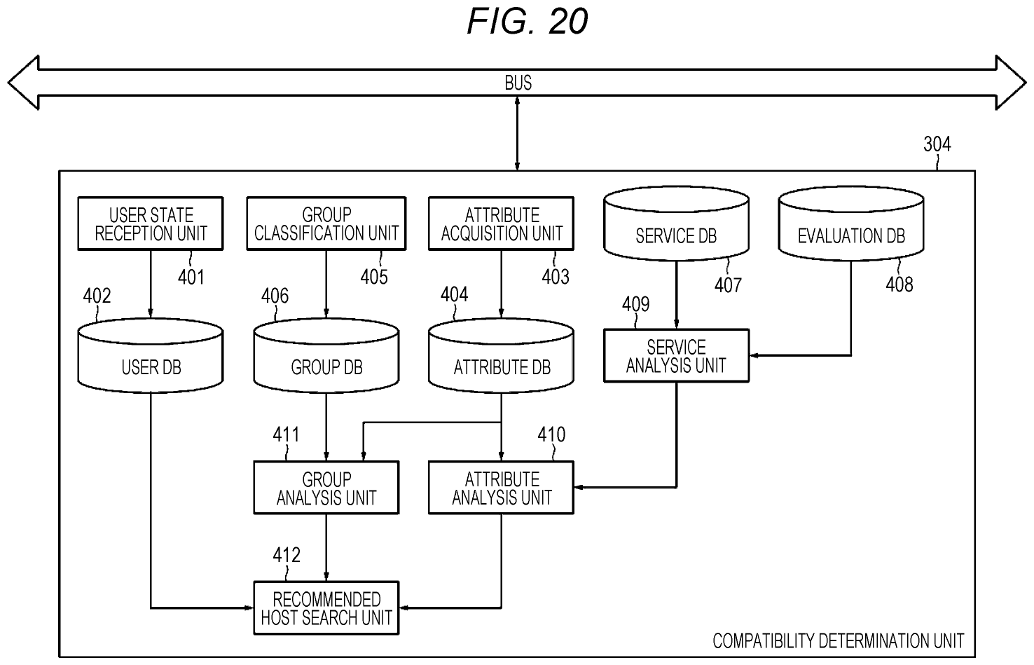

First, the configuration of the compatibility determination unit 304 will be described with reference to FIG. 20.

The compatibility determination unit 304 includes a user state reception unit 401, a user database 402, an attribute acquisition unit 403, an attribute database 404, a group classification unit 405, a group database 406, a service database 407, an evaluation database 408, a service analysis unit 409, and an attribute analysis unit 410, a group analysis unit 411, and a recommended host search unit 412.

The user state reception unit 401 extracts and receives state information of the host user acquired by the state acquisition unit 110 from the information transmitted from the host terminal device 100, and stores the information in the user database 402. In a similar manner, a process of extracting and receiving the state information of the guest user acquired by the state acquisition unit 208 from the information transmitted from the guest terminal device 200 and storing the information in the user database 402 is performed.

The user database 402 integrally manages information of all the host users and guest users who have applied for the use of the remote communication system 10 and approved. The user database 402 also stores information such as a login status and a current position of the respective host users and guest users, and is updated at anytime.

The attribute acquisition unit 403 acquires attribute information of the host user from the host terminal device 100, and acquires attribute information of the guest user from the guest terminal device 200. Methods of acquiring attribute information may be a method of acquiring from input contents at the time of user registration of a host user and a guest user, a method of acquiring from responses obtained by transmitting a questionnaire to the host user and the guest user, and the like. Moreover, the attribute can also be acquired from information regarding various social network services (SNSs) which a host user and a guest user are using, a history of using the remote communication system 10, and the like. The usage history of the remote communication system 10 is stored in the user database 402 or the like, and the communication support device 300 preferably saves conversational voice data of the host user and guest user in all past service provision and data of text chat and stores the data in the user database 402.

The attribute database 404 stores and manages attribute information of the guest user and host user acquired by the attribute acquisition unit 403 for each user. Note that the user database 402 may function as the attribute database 404.

An attribute is a combination of preferences, features, elements, and the like of the host user. The attribute includes, as geographical elements, the size of the country, region, and city where the host user resides, the degree of economic development, population, climate, culture, lifestyle, religion, policy, and the like. Moreover, there are places where the host user frequently visits, a commuting route, a work place, home town, and the like.

Furthermore, the attributes include personal information elements such as host user's age, gender, occupation, income, educational background, family structure, language, knowledge, skills, favorite places, favorite events, favorite brands, favorite books, favorite websites, interests, concerns, hobbies, knowledge, specialties, and the like.

Furthermore, the attribute includes, as psychological elements, elements such as the user's sense of values, tastes, and lifestyle. In addition, the psychological elements include elements diagnosed from questionnaires, character diagnosis, contents posted to a various social network services (SNSs) and the like. Furthermore, the psychological elements also include elements diagnosed from the content of the user's speech, a tone of the voice, a speaking speed, pauses during conversation, and the like.

Moreover, the attribute includes, as action elements, elements such as user's action history, purchase history, viewing history, moving route, transport, going out frequency, contact information, friend list in various SNSs, reviews, and the like.

Note that the elements included in the attribute are not limited to the contents described above.

The group classification unit 405 classifies the host users into groups on the basis of the attributes of the host users acquired by the attribute acquisition unit 403, and further classifies the guest users into groups on the basis of the attributes of the guest users.

The group database 406 stores and manages group information in which the host user and the guest user are classified by the group classification unit 405.

The group is an index for classifying what kind of person the host user and the guest user are and a plurality of groups is defined, which are, for example, a first group for a person having an attribute such as introverted, senses, thoughtful, and decisive and a second group for a person having an attribute such as extroverted, intuitive, emotional, and flexibility.

The group may be predefined by a known analysis method such as personality assessment, or may be dynamically generated by an analysis method such as machine learning. Geographic variables such as residence and nationality, artificial variables such as age, gender, and the like are obtained by a manual input from the user or other service linkages that already stores the data, and are stored in the attribute analysis unit 410. Psychological variables, such as introverted or extroverted, intuitive or logical, decisive or not, and the like are quantified and classified by a method such as a psychological judgment test prepared in advance. An example of the method is described below.

A first example is a method of using a questionnaire about sense of values. For example, in response to the questionnaire “Which type are you?”, answers such as “A. Challenge a wide variety of things” and “B. Focus on one thing to master it”.

A second example is a method of letting the user select a preferable photo in a questionnaire such as “Please select a room you like (as presenting some photos of rooms)”.

A third example is a method of classifying on the basis of content of speech, tone, speed, or pausing of the voice, and the like. For example, the time of active speaking is detected and classified by a topic at that time.

It is assumed that a definition of the group is set in advance and stored in the group analysis unit 411. The group definition method may be for defining by a classification model prepared in advance (for example, cool: introspected, logical, and decisive, or romantic: extroverted, intuitive, and emotional), or for automatically defining in a case where a combination of extracted attributes are common in many users (for example, Japanese men who often go to bookstores). Furthermore, an operator of the remote communication system 10 may define a new type of group and make additional settings at anytime. In a case where the attribute information of the user as the basis of classification is insufficient and the accuracy of the group classification is low, the attribute information can be compensated by asking a guest user a question or issuing a questionnaire.

Depending on the attribute that the user has, a user may be determined to belong to a plurality of groups instead of one, and other guest users belonging to the same group are defined to have the same characteristic. Furthermore, a group also defines a characteristic, such as what kind of things the user is sensitive and what kind of things the user is insensitive, regarding the user belonging to the group. With this configuration, superiority and inferiority of responses elicited mutually with other groups are quantified.

The service database 407 associates information of services provided by all host users in the past with information of the all host users, and stores and manages the information.

The evaluation database 408 stores and manages the evaluation of the guest user by the host user transmitted from the host terminal device 100 after the service provision, and the evaluation of the host user by the guest user transmitted from the guest terminal device 200. Note that the user database 402 may function as the evaluation database 408.

The service analysis unit 409 acquires a request from a guest user, acquires service information from the service database 407, and further acquires evaluation information of a host user by a guest user from the evaluation database 408. Then, a host user who has provided a service in the past same as or similar to the request from the guest user is extracted.

The attribute analysis unit 410 analyzes and quantifies a correlation between the attribute of the host user extracted by the service analysis unit 409 and the evaluation of the service performed by the extracted host user in the past. The quantified value is a score to be applied to the attribute. The evaluation may include an evaluation made by the guest user after the end of the service, and an evaluation report created by the guest user after the end of the service.

The group analysis unit 411 determines compatibility between groups on the basis of characteristics in which each group is defined in advance, and extracts a group that is compatible with the group to which the guest user belongs from among all the groups. This compatibility is defined by a score. Note that one person belongs to a plurality of sensitivity groups. For example, a person may belong to both group 1 “classified as an explorer in a personality test” and group 2 “Japanese men who often go to bookstores”. The degree of compatibility between each group may be previously defined and quantified by a psychologist, or may be dynamically quantified by a learning model based on evaluation by the past users. For example, the compatibility between a guest user of a group classified as an explorer in the personality test and a host user of a group classified as a caretaker is statically defined as a good compatibility degree (90%) by a psychologist in some cases, or the host users and guest users who are “Japanese men who often go to the bookstore” may be evaluated dynamically from past user evaluation results in other cases.

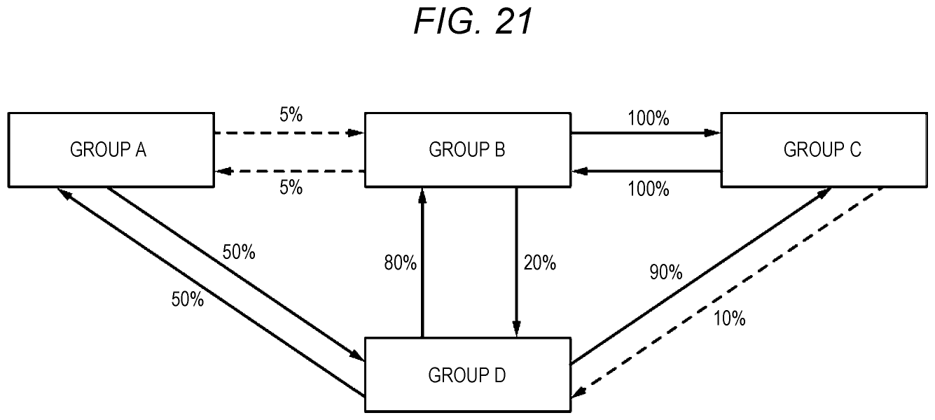

Furthermore, the compatibility of the group is not unidirectional. As illustrated in FIG. 21, for example, between two groups of group C and group D, the group D may have a good impression of group C but the group C may not have a good impression of group D. For example, in a case where a user belonging to group D having attributes of extroverted and caring is a host user, and a user belonging to a group C having attributes of carefree and selfish is a guest user, the two groups are considered to be compatible. Conversely, in a case where a user belonging to the group D having the attributes of extroverted and caring is a guest user, and a user belonging to the group C having the attributes of carefree and selfish is a host user, it is considered that the two groups are incompatible. The compatibility between the groups is quantified from 0 to 100′, and the average value of the quantification of all groups is calculated as the final degree of compatibility.

Note that the group compatibility is not unidirectional. As illustrated in FIG. 21, for example, between two groups of group C and group D, the group D may have a good impression of group C but the group C may not have a good impression of group D. For example, in a case where a user belonging to group D having attributes of extroverted and caring is a host user, and a user belonging to a group C having attributes of carefree and selfish is a guest user, the two groups are considered to be compatible. Conversely, in a case where a user belonging to the group D having the attributes of extroverted and caring is a guest user, and a user belonging to the group C having the attributes of carefree and selfish is a host user, it is considered that the two groups are incompatible.

The recommended host search unit 412 searches for a compatible host user who can provide a service in response to a request from a guest user among all host users on the basis of a group analysis result and an attribute analysis result. The host user extracted as being compatible by the recommended host search unit 412 is transmitted to the guest terminal device 200 as recommended host user information. Note that more than one host user may be determined to be compatible. It is preferable that a plurality of compatible host users be extracted and presented to the guest user, and the guest user selects from the host users.

The communication support device 300 is configured as described above. Note that some functions such as the attribute acquisition unit 403 may be provided in the host terminal device 100 or the guest terminal device 200.

### [1-6. Compatibility Determination Process]

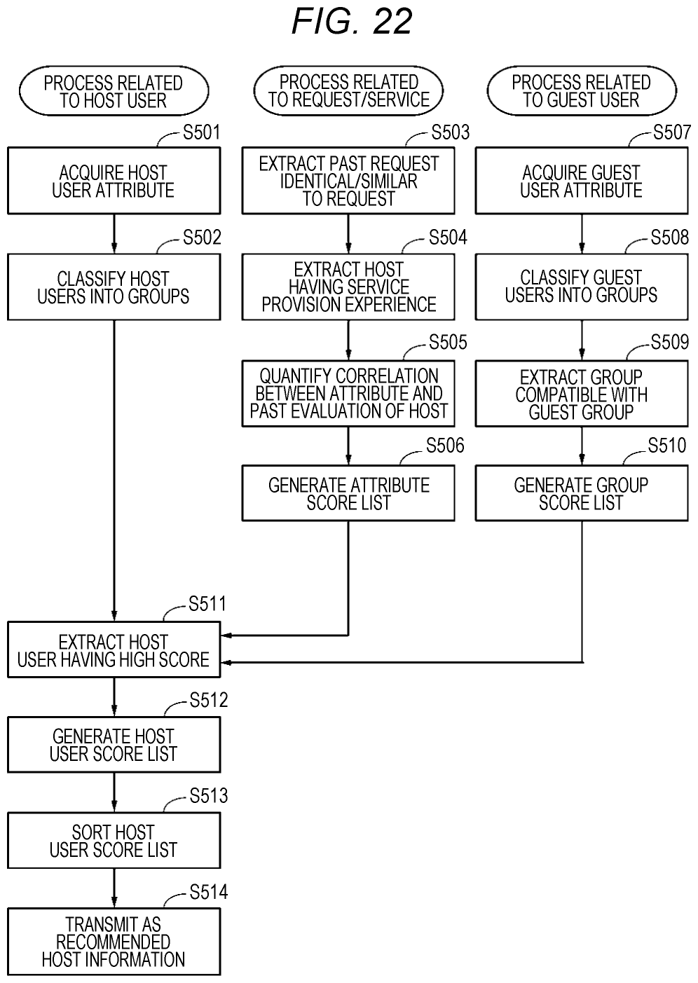

Next, details of the compatibility determination process by the compatibility determination unit 304 will be described. FIG. 22 is an explanatory diagram of the compatibility determination process. Steps S501 and S502, and steps S511 to S513 are processes related to the host user, steps S503 to S506 are processes related to the request/service, and steps S507 to S510 are processes related to the guest user. Note that the processes related to the host user in steps S501 and S502, the processes related to the request/service in steps S503 to S506, and the processes related to the guest user in steps S507 to S510 do not necessarily have to be performed in the illustrated order but all the processes need to be performed before the process in step S511. All the processes may be performed in parallel, or any of the processes may be performed first.

In the process related to the host user, firstly, as indicated in step S501, the attribute acquisition unit 403 acquires attribute information of all host users connected to the communication support device 300.

Next, as indicated in step S502, the group analysis unit 411 classifies all host users whose attribute information has been acquired into groups on the basis of the attribute information.

In the process related to the request/service, firstly, as indicated in step S503, the service analysis unit 409 extracts, from the service database 407, a past request that is the same as or similar to the request accepted from the guest user. Regarding the request similar to the guest user's request, for example, in a case where the request is “I want to go to Nara”, since it is considered to be a request for a remote travel experience, a request including the word “Nara” or a request for remote travel experiences are determined to be a similar request in the determination for a same or similar word in the request. This process can be done by referring to the service database 407.

Next, in step S504, the service analysis unit 409 extracts, from all host users connected to the communication support device 300, a host user who has provided a service for the request that is the same as or similar to the request from the guest user. This process can be done by referring to the service database 407. Next, as illustrated in step S505, the service analysis unit 409 quantifies a correlation between the extracted attribute of the host user and the evaluation of the service provided by the extracted host user in the past. The evaluation of the service provided in the past can be obtained by referring to the service database 407 and the evaluation database 408.

The quantified value is a score to be applied to the attribute. The evaluation may include an evaluation given by the guest user after the end of the service, and an evaluation report created by the guest user after the end of the service.

The score given to the attribute on the basis of the correlation between the attribute and the evaluation indicates how much each of the plurality of attributes possessed by the extracted host user has contributed to the evaluation of the host user in the past. Therefore, while there are a large number of host users who have received high evaluation in specific service provision in the past, it can be recognized that a host user with which attribute has received higher evaluation and, conversely, a host user with which attribute has received lower evaluation. For example, in a case there are some host users having one of the plurality of attributes possessed by the extracted host user have received higher evaluation and, in a case where there are a predetermined number or more of those host users with the higher evaluation, a higher score is applied to the attribute. On the other hand, there are some host users having one of the plurality of attributes possessed by the extracted host user have received a lower evaluation and, in a case where there are a predetermined number or more of those host users with the lower evaluation, a lower score is applied to the attribute. This scoring is performed for all the attributes possessed by all the extracted host users. With this configuration, it is possible to recognize with a score which attribute in the attributes possessed by the host user is an attribute desirable for providing a service for a request from a guest user.

For example, in a case where a guest user's request is “I want to go to Nara” and, while there is a plurality of host users who have provided services for the same or similar past request of “Nara sightseeing”, a predetermined number or more of the host users who have received high evaluation have attributes such as “familiar with the area”, “age in thirties or older”, and “fond of drinking alcohol” in the attributes of the plurality of host users, higher scores are applied to those three attributes.

Furthermore, in a case where the guest user's request is “Shibuya sightseeing” and, while there is a plurality of host users who have provided a service for the same or similar past request of “Shibuya sightseeing”, a predetermined number or more of host users who have received high evaluation have attributes such as “extroverted” age in twenties”, and “fond of fashion” in the attributes of the host users, higher scores are applied to those three attributes.

Next, in step S506, a list of scored attributes (referred to as an attribute score list) is generated as described above.

In the processes related to the guest user, the attribute acquisition unit 403 first acquires attribute information for all guest users in step S507.

Next, as indicated in step S508, the group analysis unit 411 classifies the guest users who have made the request into groups on the basis of attribute information. The group classification method is similar to what is described in step S502.

Next, in step S509, the group analysis unit 411 extracts a group that is compatible with the group to which the guest user belongs from all the defined groups.

Next, in step S510, a list of groups whose compatibility is defined by scores (referred to as a group score list) is generated.

Then, in the processes related to the guest user, the recommended host search unit 412 refers to the attribute information, the attribute score list, and the group score list of all host users in step S511, and extracts host users who have an attribute with a high score and belongs to a group with a high score from the all host users to make a list. This list is referred to as a host user score list. The attributes with high scores are, for example, the top three attributes by sorting the attribute score list in the order of high scores. Furthermore, the sensitivity group having a high score is a top three sensitivity groups, in which group scores are sorted in the order of high score.

Then, as indicated in step S512, a host user score list is generated. Next, in step S513, all host users in the host user score list are sorted in the order of host users having a high score attribute and belonging to a higher score group.

Then, as indicated in step S514, the top one or a plurality of host users in the host user score list sorted is recommended as a host user compatible with the guest user. Information regarding the compatible host user is transmitted from the communication support device 300 to the guest terminal device 200 as recommended host user information, and displayed on the display unit 205 of the guest terminal device 200 as illustrated in FIGS. 11A and 11B.

As described above, the compatibility determination process according to the present technology is performed. In the present technology, by performing the compatibility determination as described above, compatibility determination in consideration of conversational compatibility, the subjectivity of the host user based on knowledge and situation, the common points between the host user and the guest user, and the like can be performed.

Conversational compatibility is a comfortable service including a preferable way the host user speaks, preferable choices of words, a preferable way conversation proceeds, a preferable amount of the conversation, and the like for example can be provided to the guest user, and this helps to provide further preferable services. The subjectivity of the user based on knowledge or situation is, for example, the host user's knowledge of a particular location or a thing, or information, opinions, experiences, and the like that can only be obtained from that host user on the basis of the current situation of the host user. It is thought that conversations during service provision can be floated by the common points between the host user and the guest user, and a better service can be provided.

In a service implemented by a help of someone encountered on the Internet, the user needs to communicate with a stranger and quality of the service may be greatly influenced by the compatibility with the user. In the past, the method of judging the merits and demerits of the service provided by the person on the basis of an evaluation comment and an evaluation score by a general user was well known. However, with this method, it is unclear whether the sensitivities of other evaluators agree with the user's sensibility, and it was difficult to judge whether the evaluation result is useful for the user.

On the other hand, according to the present technology, the compatibility between the guest user and the host user is not determined, but the compatibility is determined on the basis of how much the service provided by the host user is compatible with the request from the guest user. Therefore, a most preferable host user for the service provision can be recommended, regardless of personal compatibility with the guest user. Therefore, for example, a host user that is compatible as a provider of a specific service to a guest user can be recommended even if the host user may not be compatible in a relationship as a couple, friends, a teacher and a student, and the like.

Note that, although the host user compatible with the guest user is determined in the above-described compatibility determination, there may be a case where the compatible host user is already connected to another guest user and is not available. In such a case, recommended host information including a host user who is compatible but not available may be transmitted to the guest user, or the unavailable host users may be excluded from the recommended host information. It actually depends on the operation of the remote communication system 10. Furthermore, the compatibility determination process may be limited to the currently connectable host users.

### 2. Modification Examples

In the above, an embodiment of the present technology has been described in detail; however, the present technology is not limited to the above described embodiment and various modifications within a scope of the present technology can be made.

The present technology can be applied not only to the remote travel experience described in the embodiment, but also to various services that can be realized by person-to-person communication via live video, text chat, voice communication, and the like.

For example, there may be a service in which a host user shoots a video of a product at a store and a guest user confirms the video and requests to buy the product in place of the guest user, or a service in which a guest user has a problem with a home appliance, a car, a personal computer, or the like and receives advice from a host user to repair.

Furthermore, in the compatibility determination process, the speech contents of the host user and the guest user during service provision are analyzed, and it is detected whether the host user uses a word having a low degree of recognition for the guest user or the like to analyze a degree of the guest user's understanding and the analysis may be added to the elements for compatibility determination. Whether or not the word has a low degree of recognition can be determined, for example, by confirming whether the guest user has given a predetermined word such as “What is it?” or “I do not know” after the host user speaks.

Furthermore, the expressions (impressive expressions) that strongly impress the guest user are analyzed for each attribute of the guest user and the group classification, and those expressions may be added to the element for compatibility determination to see whether the expression is used by the host user.

Moreover, the tendency of expression such as intonation and speed of speech of the host user and the formality of words to be used may be detected and added to the element for the compatibility determination with the guest user. In the embodiment, although it has been described that the billing payment is performed on the basis of the billing per unit time of the communication connection, the billing payment is not limited thereto, and a monthly flat rate system or the like may be employed or the guest user may have a choice to determine the payment amount. Note that the present technology may also have following configurations.

(1)

A communication support device including:

a compatibility determination unit configured to determine compatibility between a guest user who requests provision of a service and a host user who provides the service to the guest user;
a communication unit configured to transmit a compatibility determination result to a terminal device of the guest user; and
a connection processing unit configured to perform a connection process between the terminal device of the guest user and a terminal device of the host user.
(2)

The communication support device according to (1),

in which the connection process is performed in a case where a request for communication connection to the terminal device of the host user is received from the terminal device of the guest user on the basis of the compatibility determination result.
(3)

The communication support device according to (1) or (2),

in which in a case where a service request is received from the guest user, the compatibility determination unit determines compatibility between the single guest user who has transmitted the request and a plurality of host users.
(4)

The communication support device according to any one of (1) to (3),

in which the compatibility determination unit determines compatibility on the basis of an attribute of the host user and an attribute of the guest user.
(5)

The communication support device according to (4),

in which the compatibility determination unit classifies the host users and the guest users into groups on the basis of the attributes and determines compatibility on the basis of compatibilities between the groups.
(6)

The communication support device according to any one of (1) to (5),

in which the compatibility determination unit determines compatibility on the basis of an attribute for the provision of the service.
(7)

The communication support device according to (6),

in which the attribute for the provision of the service is an attribute of a host user having a score equal to or greater than a predetermined value in host users who have a provided service same as or similar to the service requested from the guest user.
(8)

The communication support device according to any one of (1) to (7),

in which the compatibility determination unit extracts one or more of the host users who are compatible with the guest user, from the plurality of host users.
(9)

The communication support device according to any one of (1) to (8),

in which as the compatibility determination result,
information of one or more of the host users determined to be compatible with the guest user is transmitted to the terminal device of the guest user.
(10)

The communication support device according to any one of (1) to (9),

in which the service represents that the host user responds to the request from the guest user via a network.
(11)

The communication support device according to any one of (1) to (10),

in which information related to the host user determined to be compatible with the guest user is transmitted together with the compatibility determination result.
(12)

The communication support device according to any one of (1) to (11),

in which an image being captured by the terminal device of the host user is received and transmitted to the terminal device of the guest user.
(13)

The communication support device according to any one of (1) to (12),

in which sound data is transmitted and received between the terminal device of the host user and the terminal device of the guest user.
(14)

The communication support device according to any one of (1) to (13),

in which sound data is transmitted and received between the terminal device of the host user and the terminal device of the guest user.
(15)

The communication support device according to any one of (1) to (14),

in which after the service provision is completed, evaluation of the host user is received from the guest user and evaluation of the guest user is received from the host user.
(16)

A communication support method including:

determining compatibility between a guest user who requests provision of a service and a host user who provides the service to the guest user;
transmitting a compatibility determination result to a terminal device of the guest user; and
performing a connection process between the terminal device of the guest user and a terminal device of the host user.
(17)

A program that causes a computer to perform a communication support method, the method including:

determining compatibility between a guest user who requests provision of a service and a host user who provides the service to the guest user;
transmitting a compatibility determination result to a terminal device of the guest user; and
performing a connection process between the terminal device of the guest user and a terminal device of the host user.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Host terminal device
200 Guest terminal device
300 Communication support device
303 Communication unit
304 Compatibility determination unit
305 Connection processing unit

1. A communication support device comprising:
a compatibility determination unit configured to determine compatibility between a guest user who requests provision of a service and a host user who provides the service to the guest user;
a communication unit configured to transmit a compatibility determination result to a terminal device of the guest user; and
a connection processing unit configured to perform a connection process between the terminal device of the guest user and a terminal device of the host user.

2. The communication support device according to claim 1,
wherein the connection process is performed in a case where a request for communication connection to the terminal device of the host user is received from the terminal device of the guest user on a basis of the compatibility determination result.

3. The communication support device according to claim 1,
wherein in a case where a service request is received from the guest user, the compatibility determination unit determines compatibility between the single guest user who has transmitted the request and a plurality of host users.

4. The communication support device according to claim 1,
wherein the compatibility determination unit determines compatibility on a basis of an attribute of the host user and an attribute of the guest user.

5. The communication support device according to claim 4,
wherein the compatibility determination unit classifies the host users and the guest users into groups on a basis of the attributes and determines compatibility on a basis of compatibilities between the groups.

6. The communication support device according to claim 1,
wherein the compatibility determination unit determines compatibility on a basis of an attribute for the provision of the service.

7. The communication support device according to claim 6,
wherein the attribute for the provision of the service is an attribute of a host user having a score equal to or greater than a predetermined value in host users who have provided a service same as or similar to the service requested from the guest user.

8. The communication support device according to claim 1,
wherein the compatibility determination unit extracts one or more of the host users who are compatible with the guest user, from the plurality of host users.

9. The communication support device according to claim 1,
wherein as the compatibility determination result, information of one or more of the host users determined to be compatible with the guest user is transmitted to the terminal device of the guest user.

10. The communication support device according to claim 1,
wherein the service represents that the host user responds to the request from the guest user via a network.

11. The communication support device according to claim 1,
wherein information related to the host user determined to be compatible with the guest user is transmitted together with the compatibility determination result.

12. The communication support device according to claim 1,
wherein an image being captured by the terminal device of the host user is received and transmitted to the terminal device of the guest user.

13. The communication support device according to claim 1,
wherein sound data is transmitted and received between the terminal device of the host user and the terminal device of the guest user.

14. The communication support device according to claim 1,
wherein text data is transmitted and received between terminal device of the host user and the terminal device of the guest user.

15. The communication support device according to claim 1,
wherein after the service provision is completed, evaluation of the host user is received from the guest user and evaluation of the guest user is received from the host user.

16. A communication support method comprising:
determining compatibility between a guest user who requests provision of a service and a host user who provides the service to the guest user;
transmitting a compatibility determination result to a terminal device of the guest user; and
performing a connection process between the terminal device of the guest user and a terminal device of the host user.

17. A program that causes a computer to perform a communication support method, the method comprising:
determining compatibility between a guest user who requests provision of a service and a host user who provides the service to the guest user;
transmitting a compatibility determination result to a terminal device of the guest user; and
performing a connection process between the terminal device of the guest user and a terminal device of the host user.
